(19) United States
(12) Patent Application Publication
(10) Pub. No.: US 2006/0076843 A1
(43) Pub. Date: Apr. 13, 2006

(54) Isolated electric power generator by utilizing leaking magnetic flux

(76) Inventor: Chin Shiou Chang, Tainan Hsien (TW)

Correspondence Address: Chin Shiou Chang, 235 Chung - Ho, Box 8-24, Taipei, TW

(21) Appl. No.: 11/287,095

(22) Filed: Nov. 28, 2005

Related U.S. Application Data
(63) Continuation-in-part of application No. 10/447,403, filed on May 28, 2003, now abandoned.

(51) Int. Cl. H02K 7/18; H02K 1/04; H02K 5/12; A45B 3/02

(52) U.S. Cl. 310/87; 310/43; 310/216; 362/102; 362/192; 290/1 R

(57) ABSTRACT

An isolated electric power generator by utilizing leaking magnetic flux i includes a ferromagnetic core, at least one coil winding the ferromagnetic core, at least one pair of output terminals, and an envelope enclosing the aforementioned parts. In the usage of the present invention, the present invention's power generator does not connect to any other electric power source system. An aquarium with the isolated electric power generator induced by leaking magnetic flux is also disclosed.

The present invention is a continuation in part (CIP) of U.S. patent application Ser. No. 10/447,403 assigned and invented by Chin Shiou Chang. Therefore the content of U.S. patent application Ser. No. 10/447,403 is incorporated into this application as a part of the specification.

### FIELD OF THE INVENTION

The present invention relates to power generators, and in particular to a device for power generation by external magnetic flux without consuming any other energy, and without connecting to any other electric power source system.

### BACKGROUND OF THE INVENTION

The prior devices similar to the present invention, such as magnetic detector and power generating equipment, must use battery, or plug-in electric power, and even gasoline to achieve magnetic flux variation, but it will incur source waste and pollution problems. Furthermore, the prior art electric power generating devices, using gasoline or connecting to other electric power sources, have the possibility of occurring accidents or instability of the system.

### SUMMARY OF THE INVENTION

The present invention pertains to power generating devices, particularly to the power generating devices using only external magnetic flux change, without using any other energy, and without connecting to any other electric power source system.

The object of the present invention is to achieve a kind of power generating device using only external magnetic flux change, leaking from electric motor, electric power generator, or alternating electric current socket, etc., without using gasoline, or other electric energy and without connecting to any other electric power source system, and to provide a kind of power generating device with advantage of energy saving, no pollution and safety.

The physical principle of present invention is Faraday's law, stating that the electromotive force induced by a changing magnetic field is proportional to the changing rate of magnetic flux.

### BRIEF DESCRIPTION OF THE DRAWINGS

FIG. 1 illustrates a schematic view of the present invention

FIG. 2 shows the interior construction of the present invention.

FIG. 3 is a perspective view of the present invention

FIG. 4 shows one application of the present invention, in that the present invention is used to an aquarium.

FIG. 5 shows another application of the present invention, wherein the present invention is applied to another kind of aquarium.

FIG. 6 shows that the present invention is used as a decoration of a scenery.

FIGS. 7(A) to 7(L) show that the present invention can be formed with various outlooks.

### DETAILED DESCRIPTION OF THE REFERRED EMBODIMENTS

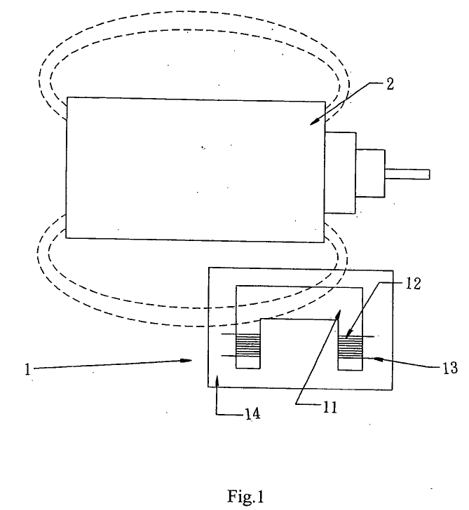

FIG. 1 illustrates the acting principle of the power generator 1 of the present invention, which comprises: a ferromagnetic core 11, at least one coil 12 winding the ferromagnetic core 11, at least one pair of electric output terminals 13 extending from the coil 12, wherein the number of the pairs depends on the individual design. As the electric motor 2 emits a changing magnetic flux, the power generator 1 converts the changing magnetic flux into an electromotive force.

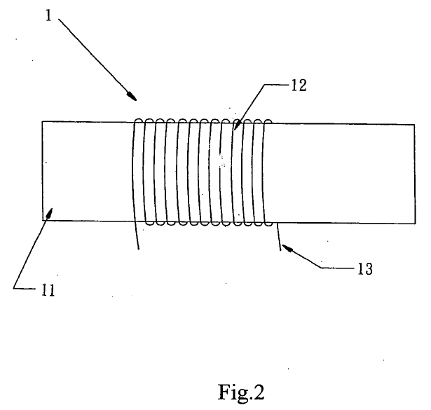

FIG. 2 illustrates the interior construction of the present invention.

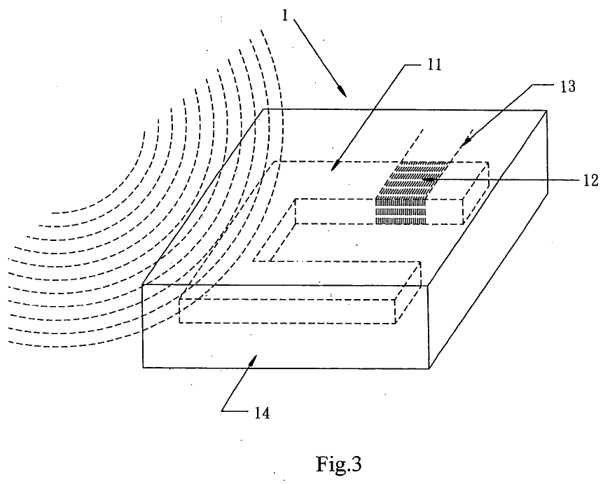

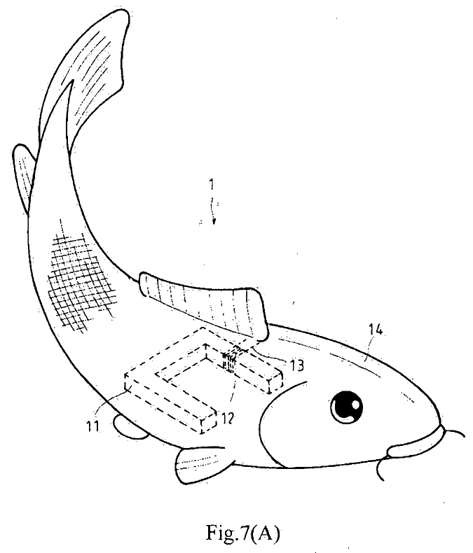

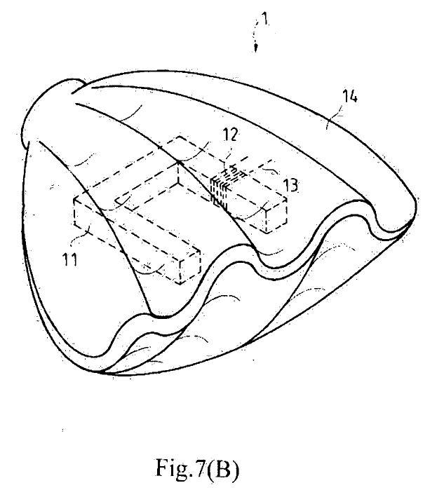

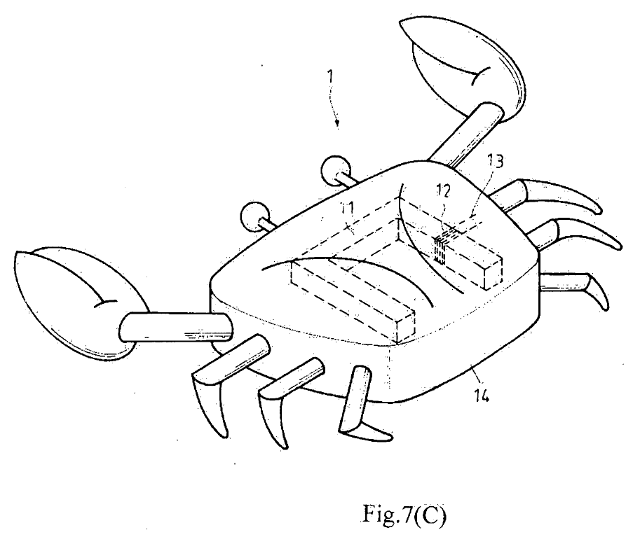

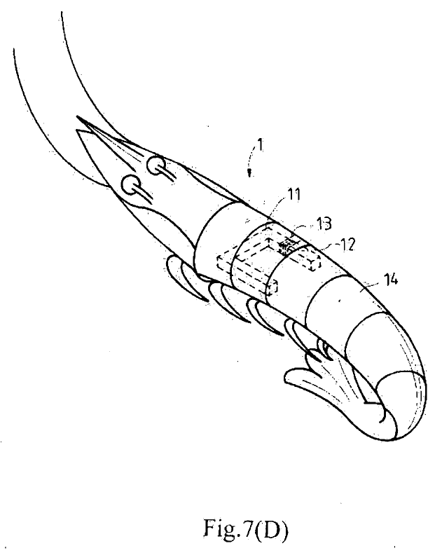

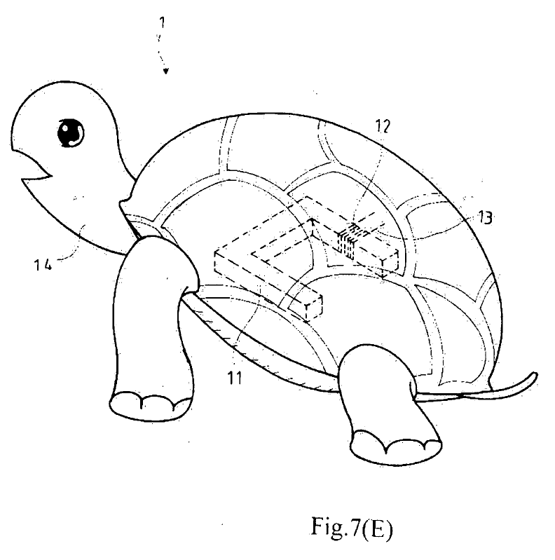

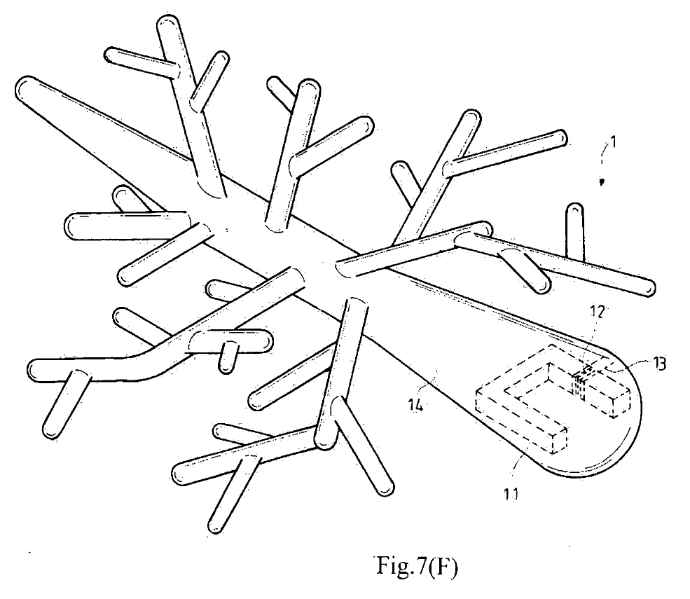

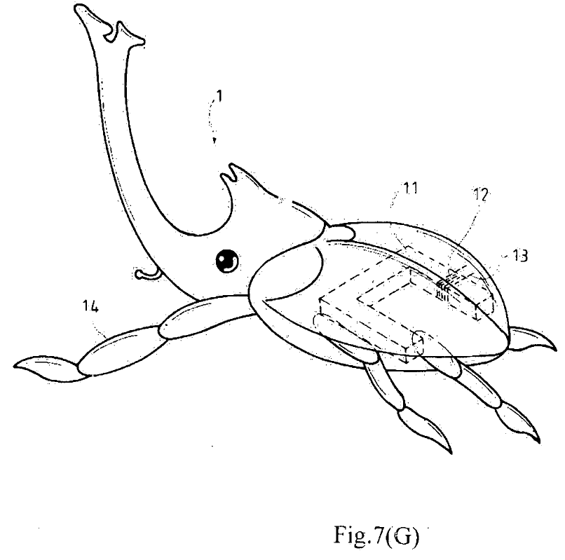

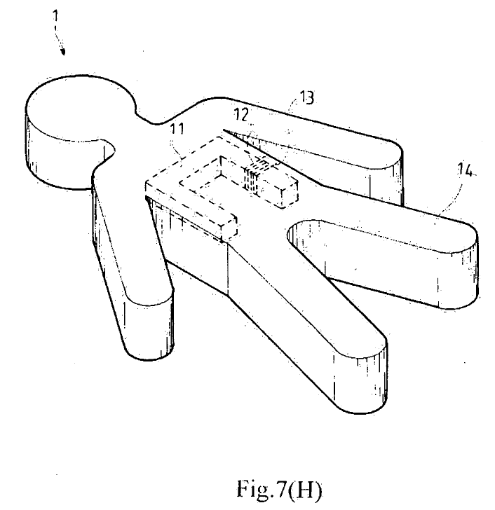

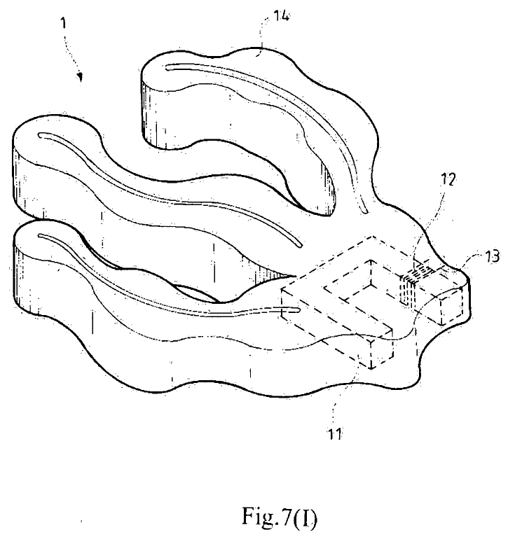

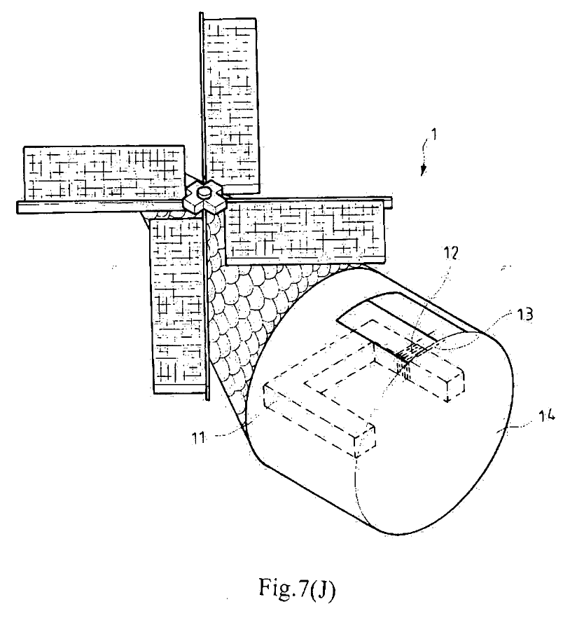

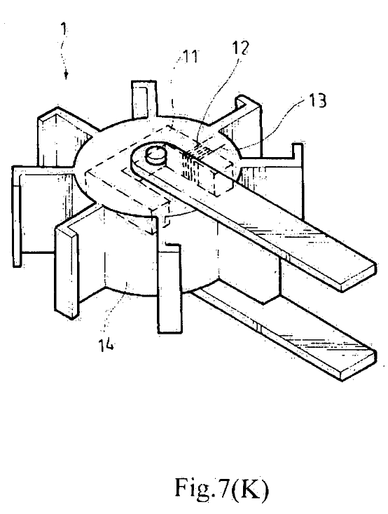

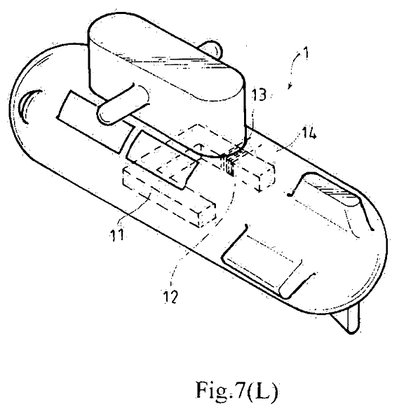

FIG. 3 illustrates the enveloped package of the present invention, wherein ferromagnetic core 11 is wound by the coil 12, and the output terminals 13 extend from the coil 12. An envelope 14 encloses elements mentioned above. The number of the coils 12 depends on the need of design. Referring to FIG. 7(A) to 7(L), the envelope may have various shapes, such shapes of fishes, amphibians, ocean mammals, shells, crabs, shrimps, turtles, corals, insects, mankind, waterweeds, windmills, water wheels, or submarines.

With putting the power generator of the present invention within the effective range of a varied magnetic flux, such as near an electric motor or an electric generator, the ferromagnetic core 11 absorbs and concentrates the changing magnetic flux, and induces a current in the coil 12, which provides electric energy without additional energy consumption and pollution so as to have the effects of environmental protection and safety.

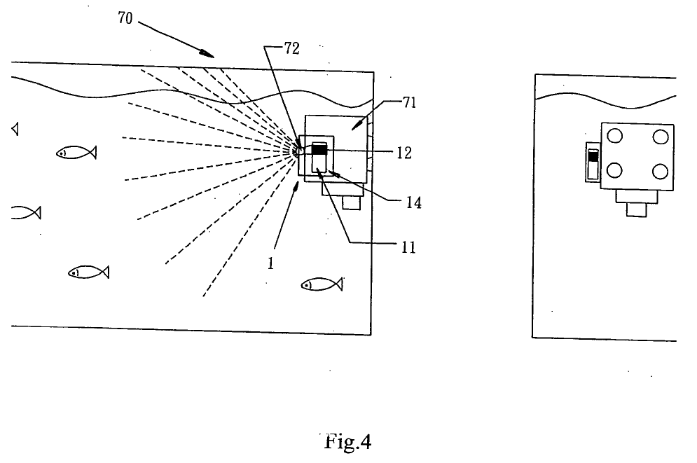

FIG. 4 illustrates that the power generator 1 of the present invention is enclosed by the envelope 14, and located near a motor 71 of an aquarium 70 so as to induce a current by converting the magnetic energy from the motor 71 of the aquarium 70. The current is used to light an aquarium lamp 72 coupled to the coil 12 without another additional energy.

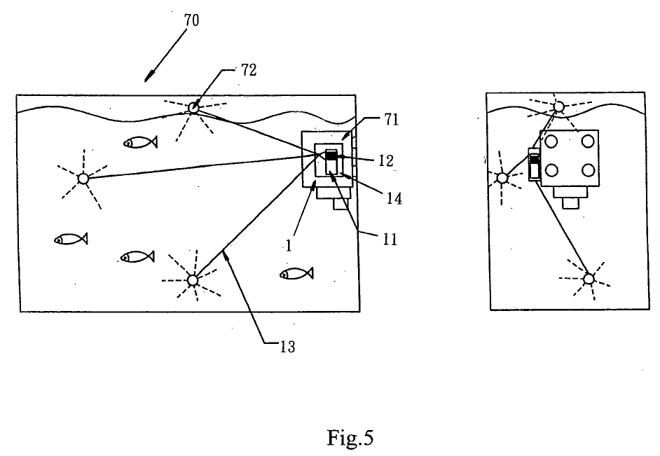

In FIG. 5, it is illustrated that the output terminals are not pulled out. In this embodiment, the aquarium lamp 72 may be a general electric lamp or a light emitting diode. The power generator 1 of the present invention does not connect to any other electric power source systems. Moreover in the present invention, the envelope 14 is a water-proof device. If there is any short circuit happening, the problem will be limited within the device and will not spread to any other places. Thus, the safety of electric usage is promoted.

FIG. 5 illustrates that three pairs of output terminals 13 extending from the present invention, which is enclosed by the envelope 14 and located near the motor 71 of the aquarium and can provide electric energy to three aquarium lamps 72. In this embodiment, the power device of the present invention affords three electric consumptions simultaneously without another additional energy. The power generator 1 of the present invention is not connected to any other electric power source systems, and in particularly the envelope 14 is a water-proof one. If short circuit occurs, the accident will be limited within the power generator 1 and will not spread to any other places. Thus, the safety of electric usage is promoted.

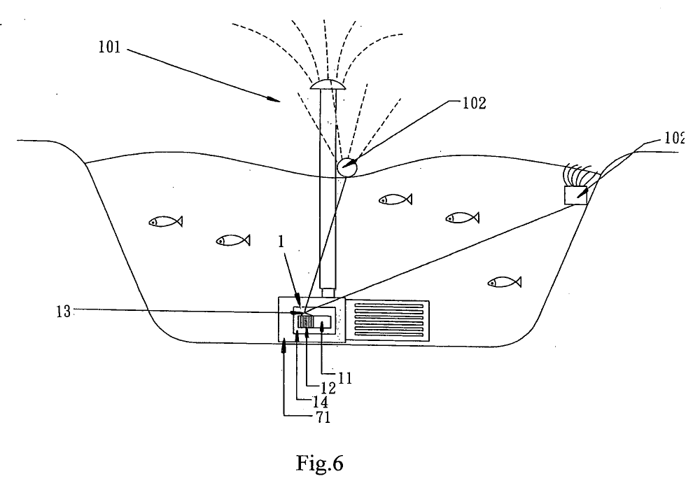

FIG. 6 illustrates that the present invention is applied to a scenery-making design. Two pairs of output terminals 13, extending from the power generator 1 which is enclosed by the envelope 14, provides current to the fog-maker 101 and scenery lamp 102 without another additional energy. The power generator 1 does not connect to any other electric power source systems, while it is also waterproof. If short circuit occurs, the problem will be limited within the device of the present invention and will not spread to any other places. Thus, the safety of electric usage is promoted.

The preferred embodiments mentioned above are able to provide one or a plurality of electric energy sources simultaneously without another additional energy. Moreover, when those are used under water, such as FIG. 4, FIG. 5, and FIG. 6, the safety of electrical usage will be promoted, since the present invention does not connect to any other electrical power source system.

It should be noted that the material of the core of the present invention includes: pure iron, low-carbon steel, silicon-iron alloy, nickel-iron alloy, nickel-cobalt alloy, soft ferrite, laminated electrical steel, or ferromagnetic amorphous alloy.

Modifications and variations can be made through the disclosed embodiments without departing from the subject of the invention as defined in the following claims.

What is claimed is:

1. An isolated electric power generator induced by leaking magnetic flux, comprising:
a ferromagnetic core,
at least one coil which winds said ferromagnetic core,
at least one pair of output terminals extending from said coil, and
a waterproof envelope enclosing a said elements and having a shape suitable for a decoration or the scenery-making inside or beside water,
wherein said isolated electric power generator will be induces to generate current by leaking magnetic flux from an outside of said power generator.

2. The isolated electric power generator induced by leaking magnetic flux according to claim 1, wherein the material of said core has an intrinsic coercivity less than 1000 Am⁻¹.

3. The isolated electric power generator induced by leaking magnetic flux according to claim 1, wherein the material of said core includes: pure iron, low-carbon steel, silicon-iron alloy, nickel-iron alloy, nickel-cobalt alloy, soft ferrite, laminated electrical steel, or ferromagnetic amorphous alloy.

4. The isolated electric power generator induced by leaking magnetic flux according to claim 1, wherein at least one light is coupled to said output terminals and enclosed inside said envelope.

5. The isolated electric power generator induced by leaking magnetic flux according to claim 3, wherein said light is selected from one of a general electric lamp and a light emitting diode.

6. An aquarium with an isolated electric power generator induced by leaking magnetic flux, comprising:
an aquarium tank;
an isolated electric power generator located within said aquarium comprising:
a ferromagnetic core,
at least one coil which winds said ferromagnetic core,
at least one pair of output terminals extending from said coil, and
a waterproof envelope enclosing all said elements and having the shape suitable for the decoration or the scenery-making inside or beside water,
wherein said isolated electric power generator will be induced to generate current by leaking magnetic flux from an outside of said power generator.

7. The aquarium with an isolated electric power generator induced by leaking magnetic flux according to claim 6, the aquarium tank comprises at least one fog-maker.

8. The isolated electric power generator induced by leaking magnetic flux according to claim 6, wherein the material of said core has an intrinsic coercivity less than 1000 Am⁻¹.

9. The isolated electric power generator induced by leaking magnetic flux according to claim 6, wherein the material of said core includes: pure iron, low-carbon steel, silicon-iron alloy, nickel-iron alloy, nickel-cobalt alloy, soft ferrite, laminated electrical steel, or ferromagnetic amorphous alloy.

10. The isolated electric power generator induced by leaking magnetic flux according to claim 6, wherein at least one light is coupled to said output terminals and enclosed inside said envelope.

11. The isolated electric power generator induced by leaking magnetic flux according to claim 10, wherein said light is selected from one of a general electric lamp and a light emitting diode.

12. The isolated electric power generator induced by leaking magnetic flux according to claim 6, wherein the envelope has a shape selected from shapes of fishes, amphibians, ocean mammals, shells, crabs, shrimps, turtles, corals, insects, mankind, waterweeds, windmills, water wheels, and submarines.

13. The isolated electric power generator induced by leaking magnetic flux according to claim 11, wherein the envelope has a shape selected from shapes of fishes, amphibians, ocean mammals, shells, crabs, shrimps, turtles, corals, insects, mankind, waterweeds, windmills, water wheels, and submarines.
